(19) United States
(12) Patent Application Publication
(10) Pub. No.: US 2008/0267647 A1
(43) Pub. Date: Oct. 30, 2008

(54) CONCENTRATION DETECTION DEVICE AND IMAGE FORMING DEVICE

(75) Inventors: Nobuhiro HORIUCHI, Osaka (JP); Koji MURASE, Osaka (JP); Hiroyuki UEDA, Osaka (JP); Hidenori TAKENAKA, Osaka (JP); Tomoyuki ODA, Osaka (JP); Jumpei HOBO, Osaka (JP)

Correspondence Address: GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 12/107,594

(22) Filed: Apr. 22, 2008

(30) Foreign Application Priority Data
Apr. 27, 2007 (JP) 2007-119762

(51) Int. Cl. G03G 15/10

(52) U.S. Cl. 399/57

(57) ABSTRACT

A concentration detection device includes a tubular member, a light-emitting member, and a light-receiving member. The tubular member includes a liquid developer inlet that inlets liquid developer, and a liquid developer outlet that discharges the liquid developer. A liquid channel through which liquid developer passes is formed in the interior of the tubular member. The light-emitting member is a member that is disposed on one end of the tubular member. The light-receiving member receives light emitted from the light-emitting member that detects concentration of the liquid developer that is inlet into the interior of the tubular member.

### CROSS-REFERENCE TO RELATED APPLICATIONS

This application claims priority to Japanese Patent Application No. 2007-119762, filed on Apr. 27, 2007, the entirety of which is hereby incorporated by reference in its entirety.

### BACKGROUND OF THE INVENTION

1. Field of the Invention

The present invention relates to a concentration detection device, and an image forming device including the same.

2. Background Information

For example, Japan Patent Application Publication JP-A-2005-315948 discloses a concentration detection device that includes a containing section with thin thickness, which is configured to hold liquid, and a light-emitting element, and a light-receiving element. Here, the light-emitting element and the light-receiving element are disposed on the both sides of the containing section. In this concentration detection device, a liquid sample is contained in the containing section, and light is emitted from the light-emitting element. Then, light emitted from the light-emitting element penetrates through the liquid sample, and is then received by the light-receiving element. Here, the concentration of the liquid sample is configured to be detected depending on intensity of the light received by the light-receiving element.

In the above concentration detection device, a liquid sample, which is made up of toner and carrier liquid, is filled in a narrow slit, and light emitted from the light-emitting element is transmitted through a thin layer formed by the liquid sample filled in the narrow slit. Then, toner concentration is detected based on the transmissive light that reaches the light-receiving element. Note that the thickness of the liquid sample (hereinafter referred to as “sample thickness”), which is filled in the narrow slit, is generally set to be several tens of micrometers (μm) to several millimeters (mm).

In the above conventional concentration detection device, the sample thickness is quite thin. Therefore, the amount of attenuation of light transmitted from the light-emitting element to the light-receiving element is small when concentration of the liquid sample is quite low (e.g., concentration is less than or equal to 0.1%). Accordingly, accuracy in detecting the concentration becomes worse.

In view of the above, it will be apparent to those skilled in the art from this disclosure that there exists a need for an improved concentration detection device, and an image forming device including the same. This invention addresses this need in the art as well as other needs, which will become apparent to those skilled in the art from this disclosure.

### SUMMARY OF THE INVENTION

An object of the present invention is to realize concentration detection with high accuracy even when the concentration of the liquid sample is low.

A concentration detection device according to a first aspect of the present invention is a concentration detection device for measuring concentration of solute or dispersoid in liquid sample that includes the combination of solute and solvent or the combination of dispersoid and dispersion medium, and includes a tubular member, a light-emitting member, and a light-receiving member. The tubular member includes an inlet for inletting liquid sample and an outlet for discharging the liquid sample, and a liquid channel for passing liquid sample is formed in the interior of the tubular member. The light-emitting member is a member that is disposed on one end of the tubular member. The light-receiving member is disposed on the other end of the tubular member, and is configured to receive light emitted from the light-emitting member for detecting concentration of the liquid sample that is inlet into the interior of the tubular member.

In this device, the liquid sample is inlet into the tubular member through the inlet, and light is emitted from the light-emitting member while the liquid sample is filled in the interior of the tubular member. Here, light emitted from the light-emitting member transmits through the liquid sample that is inlet into the interior of the tubular member, and is received by the light-receiving member for detecting concentration of the liquid sample.

Here, the liquid sample is inlet into the liquid channel formed in the tubular member. Therefore, it is possible to ensure sufficiently the sample thickness (i.e., light transmissive distance). Accordingly, the present device is configured to perform concentration detection with high accuracy, compared to a conventional concentration detection device that is configured to detect concentration of the liquid sample by emitting light with respect to a thin liquid sample layer. Especially, in the present device, the light attenuation rate becomes greater and the dynamic range becomes wide even when concentration of the liquid sample is low. Accordingly, the present device is configured to detect accurately concentration of the liquid sample.

An image forming device according to another aspect of the present invention is an image forming device for forming an image with liquid developer including toner and carrier liquid, and includes an electrostatic latent image bearing member, an electric charging device, an exposing device, a developing device, a transfer device, a cleaning device, a separation and extraction device, a concentration detection device, and a control unit. The electrostatic latent image bearing member is configured to bear an electrostatic latent image on the surface thereof. The electric charging device is configured to charge electrically the surface of the electrostatic latent image bearing member. The exposing device is configured to form the electrostatic latent image by exposing the surface of the electrostatic latent image bearing member based on image data. The developing device is configured to form a toner image by developing the electrostatic latent image with the toner by supplying the liquid developer to the electrostatic latent image bearing member. The transfer device is configured to transfer the toner image to a transfer-target. The cleaning device is configured to remove the liquid developer left on the electrostatic latent image bearing member after the toner image is transferred by the transfer device. The separation and extraction device is configured to perform a separation and extraction processing with respect to the liquid developer removed from the electrostatic latent image bearing member by the cleaning device. The concentration detection device is configured to detect concentration of the liquid developer in the interior of the separation and extraction device. The control unit is configured to judge whether the separation and extraction processing is completed in the separation and extraction device based on a result of concentration detected by the concentration detection device.

In the image forming device, the electric charging device electrically charges the surface of the electrostatic latent image bearing member, and the exposing device exposes the surface of the electrostatic latent image bearing member based on the image data. Then, a tone image is formed on the surface of the electrostatic latent image bearing member by the developing device, and the toner image is transferred to the transfer-target by the transfer device. Next, the liquid developer left on the electrostatic latent image bearing member is removed by the cleaning device, and a separation and extraction processing is performed with respect to the liquid developer removed by the cleaning device. Here, it is judged whether the separation and extraction operation is completed in the separation and extraction device based on a result of concentration detected by the concentration detection device.

These and other objects, features, aspects, and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a schematic cross-sectional view of the entire configuration of a color printer according to a preferred embodiment of the present invention;

FIG. 2 is an enlarged cross-sectional view of an image forming unit of the color printer;

FIG. 3 is a schematic cross-sectional view of the entire configuration of a liquid developer circulation device of the color printer;

FIG. 4 is an overall cross-sectional view of a concentration detection device of the liquid developer circulation device;

FIG. 5 is an exploded perspective view of the concentration detection device;

FIG. 6 is a view of a block diagram of a light-emitting member, a light-receiving member, and a control unit of the liquid developer circulation device;

FIG. 7 is a view of a chart illustrating a relation between output voltage and the concentration of solid material;

FIG. 8 is a view of a chart illustrating a relation between output voltage and light path distance under the condition where a container is made of resin and the condition where the container is made of metal; and

FIG. 9 is a view of a chart illustrating a relation between output voltage and light path distance under the condition where an inner peripheral surface is ground and the condition where the inner peripheral surface is not ground.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

An embodiment of an image forming device of the present invention will be hereinafter described with reference to the attached figures. Note that the position, the size, and the like of members in the figures are sometimes exaggerated to provide an easy-to-understand explanation. Also, in the following embodiments, a printer is exemplified as an example of the image forming device of the present invention. However, the present invention is not limited to this. Specifically, the image forming device of the present invention may be a so-called multi-function peripheral (MFP) having functions of a copier and a facsimile, or an image forming device only having a function of a copier. A specific configuration of these members to be described, and other members, may be arbitrarily changed.

### 1. Configuration

### 1.1 Overall Configuration

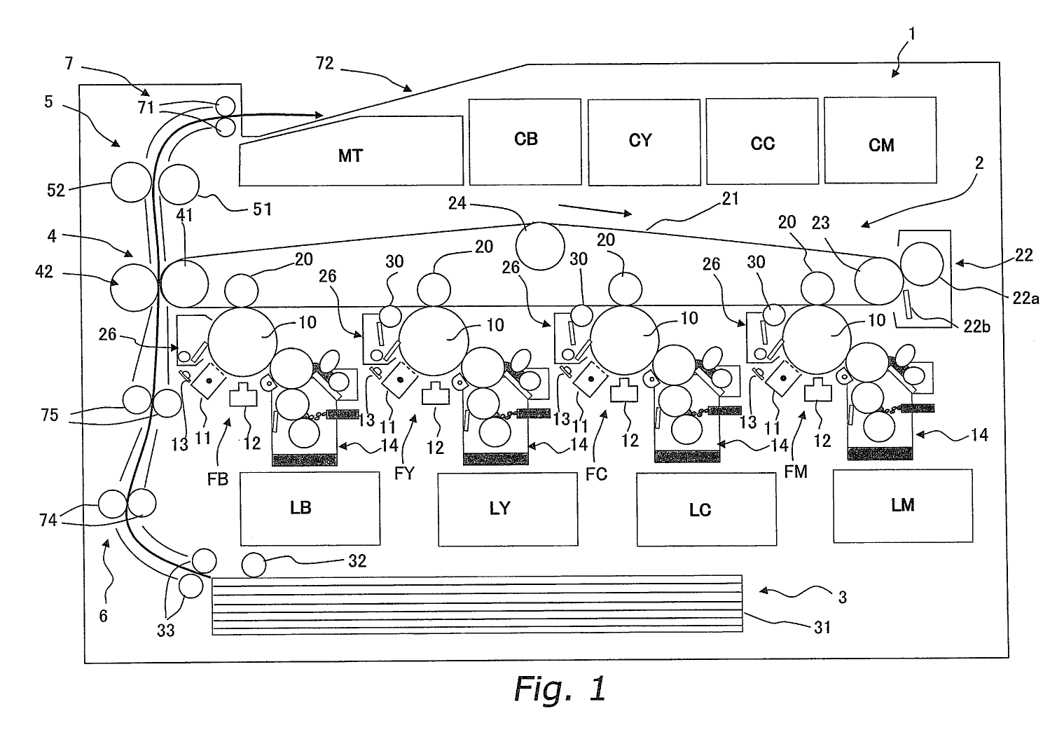

FIG. 1 illustrates a color printer 1 as an image forming device according to a preferred embodiment of the present invention. The color printer 1 includes an image forming section 2, a paper storing section 3, a second transfer section 4, a fixing section 5, a paper conveyer section 6, and a discharging section 7. The image forming section 2 is a tandem type image forming section for forming a toner image based on image data. The paper storing section 3 stores a sheet of paper, which is an example of a recording medium. The second transfer section 4 transfers the toner image formed by the image forming section 2 onto a sheet of paper. The fixing section 5 fixes the toner image transferred onto the sheet of paper. The paper conveyor section 6 conveys a sheet of paper stored in the paper storing section 3 to the discharging section 7. The discharging section 7 discharges the sheet of paper onto which the toner image is completely fixed.

The image forming section 2 includes an intermediate transfer belt 21, a cleaning unit 22, and a plurality of image forming units FY, FC, FM, and FB.

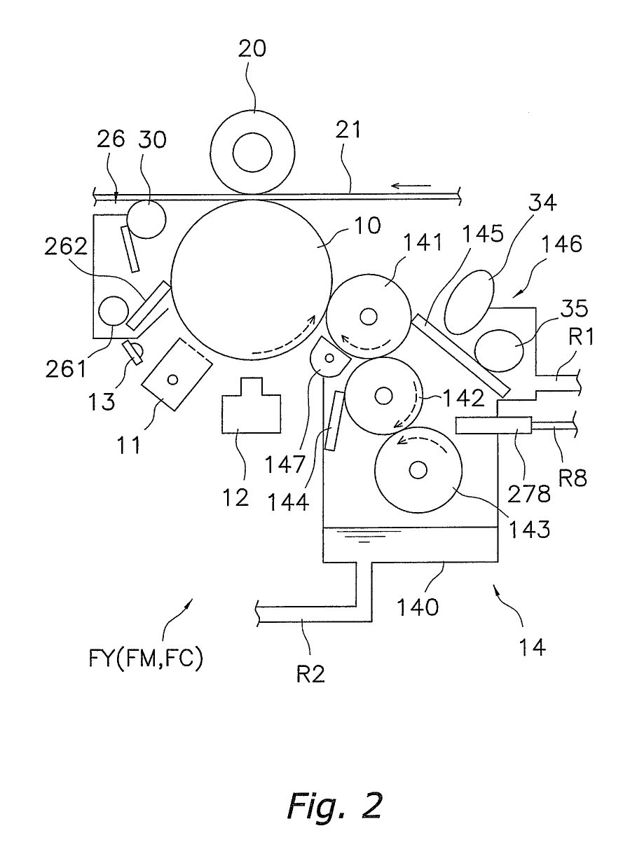

The intermediate transfer belt 21 is a conductive and endless shaped (i.e., looped) member. As indicated by arrows illustrated in FIGS. 1 and 2, the intermediate transfer belt 21 is circularly driven in the clockwise direction. The width of the intermediate transfer belt 21 is greater than the maximum width of a sheet of paper that is allowed to be used in the color printer 1. Here, the term “width” means length that is perpendicular to a direction in which a sheet of paper is conveyed. In addition, one of the surfaces of the intermediate transfer belt 21, which faces outward, is hereinafter referred to as the “front surface,” and the other surface thereof is referred to as the “back surface.” Note that the intermediate transfer belt 21 is stretched by a driving roller 41, a driven roller 23, and a tension roller 24. When the driving roller 41 rotates in accordance with driving of a driving motor (not illustrated in the figure), the intermediate transfer belt 21 is accordingly driven. In addition, when the intermediate transfer belt 21 is driven, the driven roller 23 and the tension roller 24 are rotated in accordance with the rotation of the intermediate transfer belt 21. Note that the tension roller 24 is a member for applying appropriate tension to the intermediate transfer belt 21 for the purpose of preventing the intermediate transfer belt 21 from being loosened.

The cleaning unit 22 performs cleaning of the intermediate transfer belt 21. The cleaning unit 22 includes a cleaning roller 22a and a cleaning blade 22b.

The image forming units FB, FY, FC, and FM are disposed to be aligned in the vicinity of the intermediate transfer belt 21, and are also disposed between the second transfer section 4 and the cleaning unit 22 for cleaning the intermediate transfer belt 21. The image forming units FB, FY, FC, and FM correspond to colors of black (Bk), yellow (Y), cyan (C), and magenta (M), respectively. Note that arrangement of the image forming units FB, FY, FC, and FM is not necessarily limited to the above. However, the arrangement pattern is preferable in consideration of the impact of mixture of the colors on an image to be completed.

In addition, liquid developer circulation devices LB, LY, LC, and LM, toner tanks CB, CY, CC, and CM and a main carrier tank MT are provided to correspond to the image forming units FB, FY, FC, and FM, respectively. Accordingly, the liquid developers of the colors, respectively, are configured to be supplied and recovered. Note that the liquid developer circulation devices LB, LY, LC, and LM will be described in detail in the later sections.

As illustrated in FIG. 2, each of the image forming units FB, FY, FC, and FM includes a photosensitive drum 10, an electric charging device 11, an exposing device 12, a developing device 14, a first transfer roller 20, a cleaning device 26, a neutralizing device 13, and a carrier liquid removal roller 30. In addition, the carrier liquid removal roller 30 is not provided in the image forming unit FB that is disposed in a position closest to the second transfer section 4. However, the configuration of the image forming unit FB is the same as the configurations of the other image forming units except for the aforementioned feature.

The photosensitive drum 10 (electrostatic latent image bearing member) is a columnar member, and is configured to bear an electrically-charged toner image (i.e., positively-charged toner image in the present embodiment) on the surface thereof. As indicated by a dotted arrow illustrated in FIG. 2, the photosensitive drum 10 is a member that is configured to rotate in the counter-clockwise direction.

The electric charging device 11 is a device that is configured to charge uniformly the surface of the photosensitive drum 10 to have a predetermined polarity and electric potential.

The exposing device 12 includes a light source (e.g., LED), and emits light onto the surface of the uniformly-charged photosensitive drum 10 in response to the image data to be inputted from an external machine. Accordingly, electric charges are removed from the exposed portion, and an electrostatic latent image is formed on the surface of the photosensitive drum 10.

The developing device 14 holds the liquid developer including toner and carrier so that the liquid developer is opposed to the electrostatic latent image formed on the surface of the photosensitive drum 10, and accordingly toner attaches to the electrostatic latent image. Consequently, the electrostatic latent image is developed as the toner image.

The developing device 14 includes a developing container 140, a developing roller 141, a supply roller 142, a support roller 143, a supply roller blade 144, a developing cleaning blade 145, a developer recovery device 146, and developing roller electric charger 147.

The developing container 140 is a container for receiving a supply of liquid developer that is made up of toner and carrier liquid. The liquid developer is supplied to the interior of the developing container 140 through a supply nozzle 278, while the ratio of the toner with respect to the carrier liquid is preliminarily regulated. This will be described in detail in the following sections. Note that the liquid developer is supplied toward a part of the support roller 143, more specifically, toward a vicinity of a nip between the supply roller 142 and the support roller 143. Residual supplied liquid developer drops below the support roller 143 and is stored at the bottom of the developing container 140. The stored liquid developer is recovered by the liquid developer circulation devices via a channel R2.

The support roller 143 is disposed approximately in the center of the developing container 140, and makes contact with the supply roller 142 from beneath. Thus a nip is formed between the support roller 143 and the supply roller 142. The supply roller 142 is disposed in a position obliquely upward from the support roller 143. More specifically, the supply roller 142 is disposed in a position remote from a position immediately above the support roller 143 in a direction away from the supply nozzle 278. A groove is formed on the surface of the supply roller 142 for holding the liquid developer. As indicated by dotted arrows illustrated in FIG. 2, the support roller 143 rotates in the counter-clockwise direction, and the supply roller 142 rotates in the clockwise direction.

The liquid developer to be supplied from the supply nozzle 278 is temporarily accumulated on the upstream side of the nip in the rotational direction of the both rollers 142 and 143, and is then carried upward while held in the groove formed on the supply roller 142 in accordance with rotations of the rollers 142 and 143. The supply roller blade 144 is press-contacted with the surface of the supply roller 142, and restricts the amount of liquid developer to be held by the supply roller 142 to a predetermined amount. The residual liquid developer scraped away by the supply roller blade 144 is accumulated on the bottom of the developing container 140. The accumulated liquid developer is recovered by the liquid developer circulation devices via the channel R2.

The developing roller 141 is disposed in an opening formed on the top of the developing container 140 so as to make contact with the supply roller 142. The developing roller 141 is rotated in the same direction as the supply roller 142. In other words, in the nip in which the developing roller 141 and the supply roller 142 makes contact with each other, the surface of the developing roller 141 moves in the opposite direction from the surface of the supply roller 142. Accordingly, the liquid developer held on the surface of the supply roller 142 is transferred to the surface of the developing roller 141. Here, thickness of the liquid developer layer formed on the supply roller 142 is restricted to a predetermined value. Therefore, thickness of the liquid developer layer formed on the surface of the developing roller 141 is also maintained to be a predetermined value.

The developing roller electric charger 147 moves the toner included in the liquid developer layer held on the developing roller 141 to the surface side of the developing roller 141 by applying an electric field having the same polarity as that of the charged toner. Accordingly, the developing efficiency is enhanced. The developing roller electric charger 147 is disposed to be opposed to the surface of the developing roller 141 on the downstream side in a rotational direction from a contact portion between the developing roller 141 and the supply roller 142, and on the upstream side from a contact portion between the developing roller 141 and the photosensitive drum 10.

The developing roller 141 makes contact with the photosensitive drum 10, and toner is attached to a portion of the electrostatic latent image on the surface of the photosensitive drum 10, from which electric charges are removed by the exposing device 12, by the electric potential difference between the electric potential of the electrostatic latent image on the surface of the photosensitive drum 10 and a developing bias to be applied to the developing roller 141. Accordingly, a toner image in accordance with the image data is formed on the surface of the photosensitive drum 10 (developing operation).

The developing cleaning blade 145 is disposed to make contact with the surface of the developing roller 141 on the downstream side in a rotational direction from a contact portion between the developing roller 141 and the photosensitive drum 10, and on the upstream side from a contact portion between the developing roller 141 and the supply roller 142. The developing cleaning blade 145 removes the liquid developer on the surface of the developing roller 141 that completed a developing operation with respect to the photosensitive drum 10.

The developer recovery device 146 recovers liquid developer removed by the developing cleaning blade 145, and pumps the liquid developer to a channel R1 of the liquid developer circulation devices. The liquid developer flows down along the surface of the developing cleaning blade 145. However, the developer recovery device 146 is provided with delivery rollers 34 and 35 for complementarily delivering the liquid developer because of high viscosity of the liquid developer.

The first transfer roller 20 is disposed on the back surface of the intermediate transfer belt 21 to be opposed to the photosensitive drum 10. Voltage having the opposite polarity from the toner included in the toner image (i.e., the polarity is “negative” in the present embodiment) is configured to be applied to the first transfer roller 20 by a power supply (not illustrated in the figure). In other words, the first transfer roller 20 applies voltage having the opposite polarity from the toner to the intermediate transfer belt 21 in a position that the first transfer roller 20 makes contact with the intermediate transfer belt 21. The intermediate transfer belt 21 has conductivity, and accordingly, the toner is attracted to the front surface side of the intermediate transfer belt 21 and its periphery by the applied voltage.

The cleaning device 26 is a device for removing the liquid developer left on the photosensitive drum 10 without being transferred to the intermediate transfer belt 2, and includes a cleaning blade 262 and a conveyer screw 261.

The cleaning blade 262 is a member for scraping away the liquid developer left on the surface of the photosensitive drum 10, and is also a plate shaped member that is formed to extend in a direction of the rotation shaft of the photosensitive drum 10. An end portion of the cleaning blade 262 slidingly makes contact with the surface of the photosensitive drum 10, and scrapes away the liquid developer left on the photosensitive drum 10 in accordance with the rotation of the photosensitive drum 10.

The conveyer screw 261 is disposed in the interior of the cleaning device 26. The conveyer screw 261 conveys the liquid developer, which is scraped way by the cleaning blade 262 and is contained in the cleaning device 26, to the outside of the cleaning device 26. In addition, the conveyer screw 261 also conveys the carrier liquid, which is removed from the intermediate transfer belt 21 by a carrier liquid removal roller 30 to be described and is then contained in the interior of the cleaning device 26, to the outside of the cleaning device 26.

The neutralizing device 13 includes a light source for removing electric charges, and removes electric charges from the surface of the photosensitive drum 10 by way of light emitted from the light source. After the liquid developer is removed from the surface of the photosensitive drum 10 by the cleaning blade 262, the neutralizing device 13 performs removal of electric charges for the next image formation.

The carrier liquid removal roller 30 is an approximately columnar member that is rotatable around a rotation shaft parallel to the rotation shaft of the photosensitive drum 10. The carrier liquid removal roller 30 rotates in the same direction as the photosensitive drum 10. The carrier liquid removal roller 30 is a member for removing the carrier liquid from the surface of the intermediate transfer belt 21, and is disposed in a position closed to the side that the second transfer section 4 is disposed, compared to a position in which the photosensitive drum 10 makes contact with the intermediate transfer belt 21. The carrier liquid removed by the carrier liquid removal roller 30 is stored in the interior of the cleaning device 26.

With reference to FIG. 1 again, the paper storing section 3 is a section for storing a sheet of paper onto which a toner image is to be fixed, and is disposed at the bottom of the color printer 1. In addition, the paper storing section 3 includes a paper feeding cassette 31 in which a sheet of paper is stored, a paper feeding roller 32, and a pair of paper separation rollers 33.

The second transfer section 4 is a section for transferring the toner image formed on the intermediate transfer belt 21 onto a sheet of paper. The second transfer section 4 makes up a transfer device for transferring the toner image onto a sheet of paper (transfer-target) together with the above described first transfer roller 20. The second transfer section 4 includes a driving roller 41 for driving the intermediate transfer belt 21, and a second transfer roller 42. The second transfer roller 42 is pressed toward the driving roller 41 while the intermediate transfer belt 21 is interposed between the second transfer roller 42 and the driving roller 41.

The fixing section 5 is a section for fixing the toner image onto a sheet of paper, and is disposed above the second transfer section 4. In addition, the fixing section 5 includes a heating roller 51 and a pressing roller 52. The pressing roller 52 is disposed to be opposed to the heating roller 51, and presses the heating roller 51.

The paper conveyer section 6 includes a plurality of pairs of rollers, such as a pair of conveyer rollers 74 and a pair of resist rollers 75. The paper conveyer section 6 conveys a sheet of paper from the paper storing section 3 to the second transfer section 4, the fixing section 5, and the discharging section 7. Note that only a single pair of conveyer rollers 74 is illustrated in FIG. 1. However, other pairs of conveyer rollers are also disposed to be aligned in a direction perpendicular to the diagram illustrated in FIG. 1, and illustration of the rollers is omitted in the figure.

The discharging section 7 is a section from which a sheet of paper, on which the toner image is transferred by the second transfer section 4 and fixed by the fixing section 5, is discharged. The discharging section 7 includes a plurality of pairs of discharging rollers 71 and a discharging tray 72 that is provided on the top of the color printer 1. Note that only a single pair of discharging rollers 71 is illustrated in FIG. 1. However, other pairs of discharging rollers are also disposed to be aligned in a direction perpendicular to the diagram illustrated in FIG. 1, and illustration of the rollers is omitted in the figure.

### 1.2 Configurations of Liquid Developer Circulation Devices LB, LY, LC, and LM

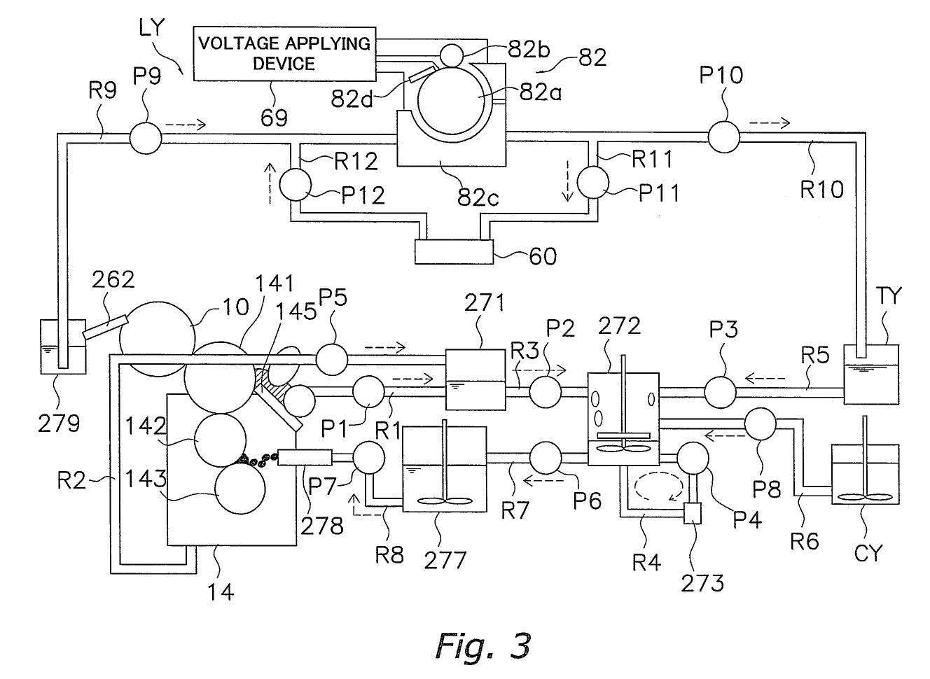

FIG. 3 illustrates a schematic view of the entire configuration of the liquid developer circulation device LY. The liquid developer circulation device LY is a device for recycling the liquid developer by the circulation of the liquid developer. A structure of the liquid developer circulation device LY is hereinafter explained. However, the structures of the other liquid developer circulation devices LB, LC, and LM are the same as the structure of the liquid developer circulation device LY. Following types of liquid developer is circulated by the liquid developer circulation device LY: the developer (a mixture of toner and carrier liquid) that is scraped away from the surface of the developing roller 141 by the developing cleaning blade 145; the developer that is not supplied from the supply roller 142 to the developing roller 141; the developer that is supplied to the support roller 143 through the supply nozzle 278 but is left as surplus developer; and the developer that is scraped away from the photosensitive drum 10 by the cleaning device 26.

The liquid developer circulation device LY includes a second recovery container 271, a regulation container 272, a solid concentration detection device 273, a carrier tank TY, a toner tank CY, a reserve tank 277, a supply nozzle 278, a first recovery container 279, a separation and extraction device 82, a concentration detection device 60, and a plurality of pumps P1-P12.

The second recovery container 271 is connected to the developing device 14 by the channel R1. The second recovery container 271 is a tank that is configured to store the developer scraped away from the surface of the developing roller 141 by the developing cleaning blade 145. In addition, the pump P1 is attached to the intermediate portion of the channel R1. The pump P1 moves the liquid developer scraped away from the surface of the developing roller 141 to the second recovery container 271. In addition, the second recovery container 271 is connected to the bottom of the developing container 140 by the channel R2, and the pump P5 is attached to the channel R2. The pump P5 delivers the liquid developer from the developing container 140 to the second recovery container 271.

The regulation container 272 is connected to the second recovery container 271, and is a member for preparing the developer (i.e., regulating the toner concentration) to be supplied to the developing device 14. The regulation container 272 is connected to the second recovery container 271 by the channel R3, and the pump P2 is attached to the channel R3. The pump P2 delivers the liquid developer from the second recovery container 271 to the regulation container 272.

The solid concentration detection device 273 is a device for detecting concentration of the toner included in the liquid developer stored in the regulation container 272, and is connected to an annular channel R4 that is connected to the regulation container 272. The pump P4 is attached to the upstream side of the solid concentration detection device 273 in the annular channel R4. The pump P4 circulates the liquid developer in the channel R4.

The carrier tank TY stores carrier liquid. The carrier liquid is used for reducing concentration of the toner stored in the regulation container 272. In addition, the carrier tank TY is connected to the regulation container 272 by the channel R5 to which the pump 3 is attached. The pump P3 delivers the carrier liquid from the carrier tank TY to the regulation container 272. Note that a carrier tank, just like the carrier tank TY, is provided in the other liquid developer circulation devices LB, LC, and LM, respectively. These carrier tanks receive a supply of the carrier liquid from the main carrier tank MT (see FIG. 1) that is shared by all the carrier tanks. The carrier tanks and the main carrier tank MT are connected by branched pipes (not illustrated in the figure), and each of the branched pipes is exclusively used by each of all the carrier tanks. In addition, a pump (not illustrated in the figure) is attached to each of the branched pipes. When the amount of carrier liquid in each of the carrier tanks is reduced to be less than a predetermined amount, a predetermined amount of carrier liquid is configured to be delivered from the main carrier tank MT to each of the carrier tanks.

The toner tank CY stores the liquid developer, the toner concentration of which is higher than that of the liquid developer to be used in the developing device 14. The liquid developer is used for increasing the toner concentration in the regulation container 272. The toner tank CY is connected to the regulation container 272 by the channel R6 to which the pump P8 is attached. The pump P8 delivers the above described liquid developer from the toner tank CY to the regulation container 272.

The reserve tank 277 is configured to store the liquid developer to be supplied to the developing device 14. The reserve tank 277 is connected to the regulation container 272 by the channel R7 to which the pump P6 is attached. The pump P6 delivers the liquid developer from the regulation container 272 to the reserve tank 277. In addition, the reserve tank 277 is connected to the supply nozzle 278 by the channel R8 to which the pump P7 is attached. The pump P7 delivers the liquid developer from the reserve tank 277 to the supply nozzle 278.

The supply nozzle 278 is a device for supplying the liquid developer to the developing device 14.

The first recovery container 279 is a container for temporarily accumulating the liquid developer that is removed from the photosensitive drum 10 by the cleaning device 26.

The separation and extraction device 82 is a device for separating the liquid developer into the toner and the carrier liquid and extracting the toner and the carrier liquid separately. The separation and extraction device 82 is connected to the first recovery container 279 by the channel R9. The pump P9 is attached to the channel R9, and the pump P9 delivers the liquid developer accumulated in the first recovery container 279 to the separation and extraction device 82. The separation and extraction device 82 separates the liquid developer to be conveyed from the first recovery container 279 into the toner and the carrier liquid, and extracts the toner and the carrier liquid. In addition, the separation and extraction device 82 is connected to the carrier tank TY by the channel R10. The pump P10 is attached to the channel R10, and the pump P10 delivers the carrier liquid separated from the liquid developer by the separation and extraction device 82 to the carrier tank TY.

Here, the separation and extraction device 82 mainly includes an electrode roller 82a, a dam roller 82b, a liquid storing container 82c, and a cleaning blade 82d. The electrode roller 82a rotates in the counter-clockwise direction in FIG. 3. The dam roller 82b makes contact with the electrode roller 82a, and rotates in the clockwise direction in FIG. 3. Also, a minute spacing is produced between the liquid storing container 82c and the electrode roller 82a. The cleaning blade 82d makes contact with the electrode roller 82a. At least the surfaces of the electrode roller 82a, the dam roller 82b, and the liquid storing container 82c are preferably made of a member to which voltage is applicable (e.g., metal or resin to which conductivity is given). In addition, the concentration detection device 60 is connected to the separation and extraction device 82, and detects concentration of the liquid developer (here, concentration of the carrier liquid extracted by the separation and extraction device 82). The concentration detection device 60 is connected to the upstream side of the separation and extraction device 82 (i.e., channel R9) by the channel R12. In addition, the concentration detection device 60 is connected to the downstream side of the separation and extraction device 82 (i.e., channel R10) by the channel R11. The channel R11 is provided with the pump P11. The pump P11 is provided for delivering the liquid developer, which is discharged from the separation and extraction device 82, to the concentration detection device 60. In addition, the channel R12 is provided with the pump P12. The pump P12 is provided for returning the liquid developer, the concentration of which is measured by the concentration detection device 60, to the upstream side of the separation and extraction device 82. The concentration detection device 60 will be hereinafter explained in detail.

### 1.3 Concentration Detection Device 60

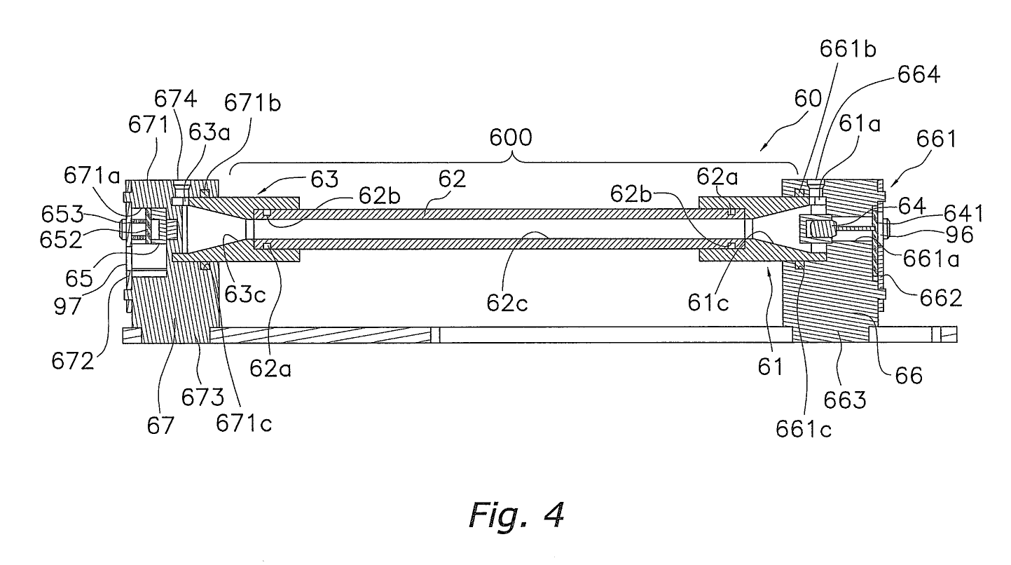

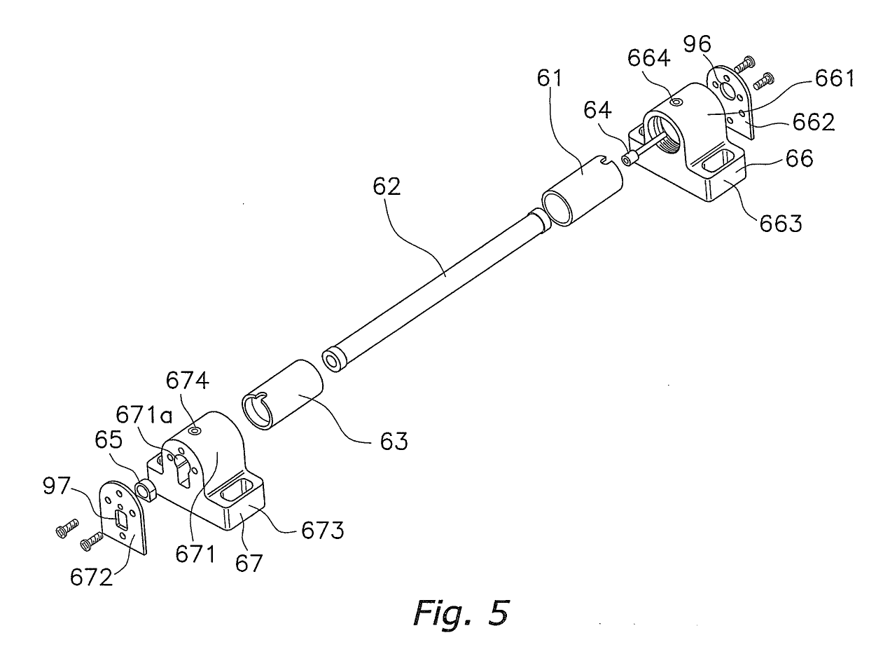

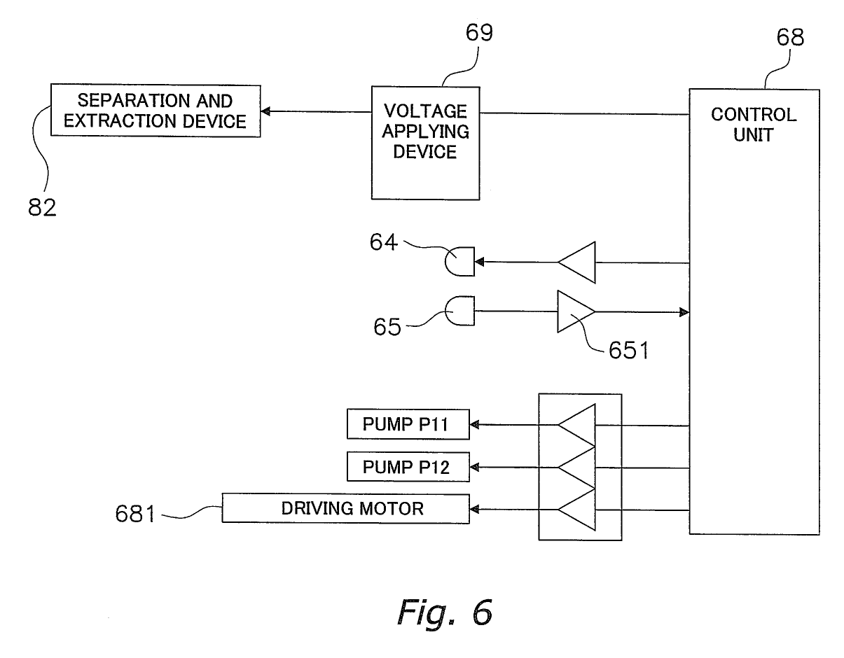

The concentration detection device 60 (see FIGS. 4 and 5) is a device for detecting concentration of the liquid developer stored in the separation and extraction device 82, and is provided in the separation and extraction device 82. Here, the liquid developer to be extracted means the carrier liquid extracted by the separation and extraction device 82. In addition, the concentration detection device 60 includes a tubular member 600, a light-emitting member 64, a light-receiving member 65, a first support member 66, a second support member 67, a control unit 68 (see FIG. 6) and a voltage applying device 69 (see FIG. 6).

The tubular member 600 includes a first tubular member 61, a second tubular member 62, and a third tubular member 63, and a liquid path through which liquid developer passes is formed in the interior of the tubular member 600. In other words, the first tubular member 61 has a first liquid channel 61c, the second tubular member 62 has a second liquid channel 62c, and the third tubular member 63 has a third liquid channel 63c through which liquid developer passes. The first, second, and third liquid channels 61c, 62c, and 63c are respectively formed on inner diameters of the first, second, and third tubular members 61, 62, and 63. The first tubular member 61, the second tubular member 62, and the third tubular member 63 are coaxially disposed. In the present embodiment, a situation that the toner concentration is reduced to 0.001% or less is defined as the completion of separation and extraction by the separation and extraction device 82. Due to this, the tubular member 600 has length suitable for detecting toner concentration of the liquid developer, which is at least less than or equal to 0.1%, more preferably, less than or equal to 0.01%. The first tubular member 61 is a cylindrical member, and includes a developer inlet 61a in one end thereof. Here, the liquid developer is allowed to be inlet through the developer inlet 61a. In addition, the first tubular member 61 is formed to have inner diameter or first liquid channel 61c that gradually reduces from one end part toward approximately the central position in a longitudinal direction. The inner surface of the first tubular member 61 is preferably made of silver alloy or aluminum alloy, which has a property that the optical absorbance is low, in other words, light is easily reflected thereby. Furthermore, the inner peripheral surface of the first tubular member 61 is ground so as to have the ten-point average roughness Rz less than or equal to 1.0 micrometer (μm), and is formed to have a mirror surface. The inner diameter of the first tubular member 61 from approximately the central position to the other end in the longitudinal direction is formed to have the same dimension as the outer shape of the second tubular member 62.

The second tubular member 62 is connected to the other end of the first tubular member 61, and is a cylindrical member having an outer shape with a diameter that is approximately the same as the inner diameter of the other end of the first tubular member 61. In addition, the inner surface or second liquid channel 62c of the second tubular member 62 is preferably made of silver alloy or aluminum alloy, which has a property such that the optical absorbance is low, in other words, light is easily reflected thereby. The inner surface of the second tubular member 62 is ground so as to have the ten-point average roughness Rz less than or equal to 1.0 micrometer (μm), and is formed to have a mirror surface. An annular groove 62b is formed in a portion of the outer peripheral surface of the second tubular member 62, which makes contact with the inner peripheral surface of the first tubular member 61. A leak prevention member 62a is fitted into the annular groove 62b. The leak prevention member 62a is an elastically deformable annular sealing member, and prevents leakage of the liquid developer. The annular grove 62b is also formed in a portion of the outer peripheral surface of the second tubular member 62, which makes contact with the inner peripheral surface of the third tubular member 63 to be described, as well. The leak prevention member 62a is fitted into the annular groove 62b.

One end of the third tubular member 63 is connected to one end of the second tubular member 62, which is opposite from the other end of the second tubular member 62 to which the first tubular member 61 is connected. A liquid developer outlet 63a is provided in the other end of the third tubular member 63, and the liquid developer is allowed to be discharged through the liquid developer outlet 63a. In addition, the third tubular member 63 is formed to have an inner diameter or third liquid channel 63c that gradually reduces from the other end side toward approximately the central position in a longitudinal direction. The inner surface of the third tubular member 63 is preferably made of silver alloy or aluminum alloy, which has a property such that the optical absorbance is low, in other words, light is easily reflected thereby. Furthermore, the inner peripheral surface of the third tubular member 63 is ground so as to have the ten-point average roughness Rz less than or equal to 1.0 micrometer (μm), and is formed to have a mirror surface. The inner diameter of the third tubular member 63 from one end side to approximately the central position in the longitudinal direction is formed to have approximately the same dimension as that of the outer shape of the second tubular member 62.

The light-emitting member 64 is disposed on one end side of the first tubular member 61, and is configured to emit light along the axis of the first tubular member 61.

The light-receiving member 65 is a member that is configured to receive light emitted from the light-emitting member 64, and is disposed on the other end side of the third tubular member 63. Accordingly, light to be emitted by the light-emitting member 64 passes through the interior of the first tubular member 61, the interior of the second tubular member 62, and the interior of the third tubular member 63, respectively, and is then received by the light-receiving member 65. In addition, the light-receiving member 65 is connected to a receiver 651 (see FIG. 6). The light-receiving member 65 converts the received light into voltage, and the receiver 651 amplifies the voltage converted from light by the light-receiving member 65.

The first support member 66 is a member for supporting the first tubular member 61, and includes a first tubular member support portion 661, a light-emitting member support portion 662, and a first base portion 663. The first tubular member support portion 661 is a tubular member, and a part of the first tubular member 61 is disposed in the inner peripheral side of the first tubular member support portion 661. In addition, a hole 664, which is allowed to be connected to the liquid developer inlet 61a of the first tubular member 61, is formed in the first tubular member support portion 661. The channel R11 (see FIG. 3) is connected to the hole 664. In addition, the first tubular member support portion 661 includes a hole 661a in which the light-emitting member 64 is allowed to be disposed. The bottom portion of the hole 661a that is opposed to the tip of the light-emitting member 64 is formed to be convex toward the first tubular member 61. In addition, the bottom portion of the hole 661a is preferably made up of a transparent resin member through which light emitted by the light-emitting member 64 is configured to penetrate. An annular groove 661c is formed in a portion of the inner peripheral surface of the first tubular member support portion 661, which makes contact with the outer peripheral surface of the first tubular member 61. A leak prevention member 661b is fitted into the annular groove 661c. The leak prevention member 661b is an elastically deformable annular sealing member, and prevents leakage of the liquid developer. The light-emitting member support portion 662 is a portion for supporting the light-emitting member 64. The light-emitting member support portion 662 is a plate shaped member that is disposed on an end of the first tubular member support portion 661, and is fixed to the first tubular member support portion 661 with a screw. The light-emitting member support portion 662 supports the light-emitting member 64 by interposing and holding a substrate 641, to which the light-emitting member 64 is attached, between the first tubular member support portion 661 and the light-emitting member support portion 662. Note that a hole 96, from which wiring (not illustrated in the figure) from the substrate 641 is extracted, is formed in the light-emitting member support portion 662. The first base portion 663 is a portion that is disposed on the lower side of the first tubular member support portion 661, and is formed in a plate shape.

The second support member 67 is a member for supporting the third tubular member 63 approximately in the same height position as the first tubular member 61. The second support member 67 includes a second tubular member support portion 671, a light-receiving member support portion 672, and a second base portion 673. The second tubular member support portion 671 is a tubular member, and a part of the third tubular member 63 is disposed in the inner peripheral side of the second tubular member support portion 671. In addition, a hole 674, which is connected to the liquid developer outlet 63a of the third tubular member 63, is formed in the second tubular member support portion 671. The channel R12 (see FIG. 3) is connected to the hole 674. In addition, the second tubular member support portion 671 includes a hole 671a in which the light-receiving member 65 is disposed. The bottom portion of the hole 671a that is opposed to the tip of the light-receiving member 65 is formed to be convex toward the third tubular member 63. In addition, the bottom portion of the hole 671a is preferably made up of a transparent resin member through which light emitted from the light-emitting member 64 is configured to penetrate. An annular groove 671c is formed in a portion of the inner peripheral surface of the second tubular member support portion 671, which makes contact with the outer peripheral surface of the third tubular member 63. A leak prevention member 671b is fitted into the annular groove 671c. The leak prevention member 671b is an elastically deformable annular sealing member, and prevents leakage of the liquid developer. The light-emitting member support portion 672 is a portion for supporting the light-receiving member 65. The light-receiving member support portion 672 is a plate shaped member that is disposed on an end of the second tubular member support portion 671, and is fixed to the second tubular member support portion 671 with a screw. A spring 653 is provided between the light-receiving member support portion 672 and the substrate 652 to which the light-receiving member 65 is attached, and the light-receiving member 65 is secured by the urging force applied by the spring 653. In addition, a hole 97, from which wiring from the substrate 652 is extracted, is formed in the light-receiving member support portion 672. The second base portion 673 is a portion that is disposed on the lower side of the second tubular member support portion 671, and is formed in a plate shape.

As seen in FIG. 6, the control unit 68 is preferably made up of a CPU and a memory, for instance. The control unit 68 is connected to the voltage applying device 69, the light-emitting member 64, the light-receiving member 65, the pumps P11 and P12, and the driving motor 681 for driving the electrode roller 82a and the like, and is a member for controlling these members and devices.

The voltage applying device 69 is a device for applying voltage to the separation and extraction device 82, and is connected to the separation and extraction device 82.

### 2. Operation

### 2.1 Image Forming Operation

First, based on FIGS. 1 and 2, an image forming operation of the color printer 1 will be hereinafter explained. When the color printer 1 receives an instruction to form an image from a personal computer (not illustrated in the figure) that is connected to the color printer 1, the color printer 1 forms toner images of a variety of colors, which correspond to the received data of the image formation instruction, with the image forming units FB, FY, FC, and FM. Specifically, electrostatic latent images are formed on the surface of the photosensitive drums 10 based on the image data, and toner is supplied to the electrostatic latent images from the developing device 14. The toner images that are thus created by the image forming units FB, FY, FC, and FM are transferred to the intermediate transfer belt 21, and are overlapped with each other on the intermediate transfer belt 21. Accordingly, a color toner image is formed.

In synchronization with the formation of the color toner images, a sheet of paper, which is stored in the paper feeder cassette 31 of the paper storing section 3, is taken out of the paper feeder cassette 31 by the paper feeder roller 32, and a sheet of paper is delivered to the paper conveyer section 6 by the pair of separation rollers 33 on a one-by-one basis. The sheet of paper is delivered to the pair of resist rollers 75 by the pair of conveyer rollers 74 of the paper conveyer section 6. The posture of the sheet of paper is corrected and is temporarily stopped moving by the pair of resist rollers 75. Then, the sheet of paper is delivered into the second transfer section 4 from the pair of resist rollers 75 in synchronization with the timing of the first transfer to the intermediate transfer belt 21, and the second transfer of the color toner image on the intermediate transfer belt 21 is performed with respect to the sheet of paper by the second transfer section 4. The sheet of paper onto which the color toner image is transferred is delivered to the fixing section 5, and the color toner image is fixed onto the sheet of paper by the actions of heat and pressure.

The sheet of paper onto which the color toner image is fixed is further delivered to the discharging section 7, and is discharged to the discharging tray 72 that is provided in the outside of the color printer 1 by the pair of discharging rollers 71.

After the second transfer is completed, the liquid developer left on the intermediate transfer belt 21 is removed by the cleaning roller 22a and the cleaning blade 22b of the cleaning section 22 for cleaning the intermediate transfer belt 21.

### 2.2 Circulation Operation of Liquid Developer

Next, an operation of supplying liquid developer to the developing device 14, that is, a circulation operation of liquid developer, will be hereinafter explained based on FIG. 3.

The liquid developer left on the developing roller 141 without being supplied to the photosensitive drum 10 during the image forming operation is scraped away by the developing cleaning blade 145, and is delivered to the second recovery container 271 via the channel R1 by the action of the pump P1. In addition, the liquid developer received by the developing container 140 is also delivered to the second recovery container 271 via the channel R2 by the action of the pump P5. Then, when the regulation container 272 runs out of all the liquid developer, the liquid developer is supplied to the regulation container 272 from the second recovery container 271 via the channel R3 by the action of the pump P2. Also, the liquid developer left on the photosensitive drum 10 without being transferred to the intermediate transfer belt 21 is scraped away by the cleaning blade 262 and is stored in the first recovery container 279.

The liquid developer recovered in the first recovery container 279 is conveyed to the separation and extraction device 82 via the channel R9 by the action of the pump P9. Then, a separation and extraction processing of toner and carrier liquid from the liquid developer is performed by the separation and extraction device 82. The separation and extraction processing will be explained in detail in the following sections. The carrier liquid extracted by the separation and extraction device 82 is delivered to the carrier tank TY via the channel R10 by the action of the pump P10.

On the other hand, concentration of toner included in the liquid developer stored in the regulation container 272 is detected by the solid concentration detection device 273, and concentration regulation of the liquid developer in the regulation container 272 is performed. Here, when toner concentration is high, the carrier liquid is supplied to the regulation container 272 from the carrier tank TY via channel R5 by the action of the pump P3. On the other hand, when toner concentration is low, the liquid developer, the toner concentration of which is higher than that of the liquid developer to be used in the developing device 14, is supplied from the toner tank CY to the regulation container 272 via the channel R6 by the action of the pump P8.

Then, the liquid developer for which concentration regulation is performed, is supplied from the regulation container 272 to the reserve tank 277 via the channel R7 by the action of the pump P6 as necessary. Then, the liquid developer stored in the reserve tank 277 is delivered to the supply nozzle 278 via the channel R8 by the action of the pump P7, and is then supplied to the developing device 14 from the supply nozzle 278.

### 2.3 Concentration Detection Operation of Liquid Developer

Next, a concentration detection operation of the liquid developer stored in the separation and extraction device 82 will be hereinafter explained.

When a sensor (not illustrated in the figure) detects that a predetermined amount of the liquid developer is stored in the first recovery container 279, the pump P9 is operated based on the detection result, and accordingly the liquid developer is inlet into a space between the electrode roller 82a and the liquid storing container 82c. Here, for example, the electrode roller 82a and the dam roller 82b are rotated while the voltage of −500V is applied to the electrode roller 82a and the voltage of +500V is applied to the dam roller 82b and the liquid storing container 82c, and accordingly the toner included in the liquid developer is attracted to and attached to the surface of the electrode roller 82a. Then, only the toner attached to the electrode roller 82a passes a contact portion between the electrode roller 82a and the dam roller 82b, and the toner is removed from the surface of the electrode roller 82a by the cleaning blade 82d. Accordingly, the carrier liquid included in the liquid developer is extracted in the space between the electrode roller 82 and the liquid storing container 82c.

After extraction of the carrier liquid is performed for a predetermined period of time, concentration of the liquid developer (i.e., extracted carrier liquid) in the separation and extraction device 82 is detected for the purpose of detecting whether the liquid developer in the separation and extraction device 82 is separated into the toner and the carrier liquid, that is, for the purpose of detecting whether concentration of the toner included in the extracted carrier liquid in the separation and extraction device 82 is less than or equal to a predetermined value. This process will be hereinafter explained.

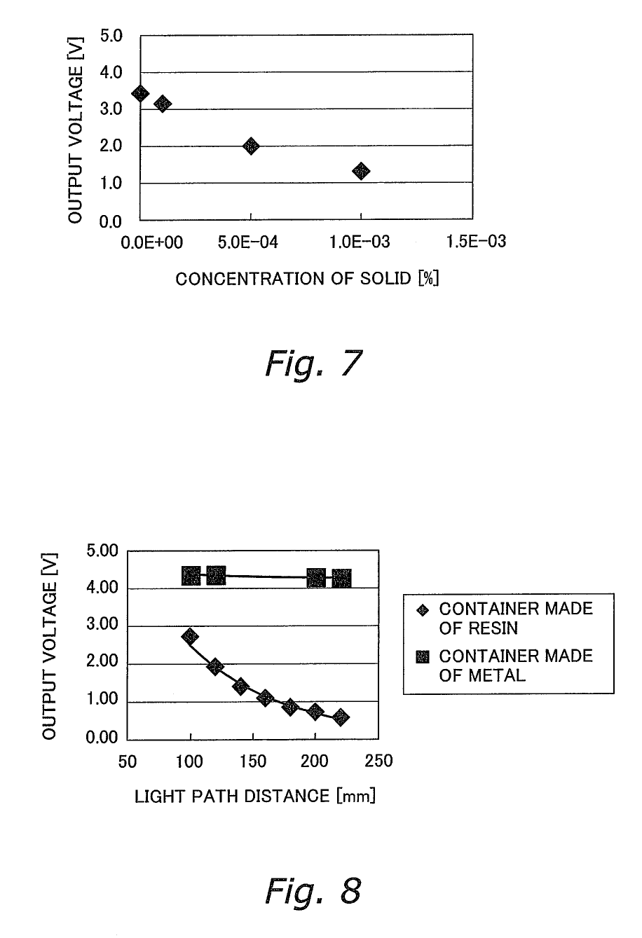

Referring to FIGS. 3, 4, and 6, first, the pump P11 is operated by the control unit 68, and the liquid developer in the separation and extraction device 82 is supplied from the liquid developer inlet 61a to the inner peripheral side of the first tubular member 61. Here, the pump P10 is kept deactivated, and accordingly the liquid developer does not flow toward the carrier tank TY. Then, light is emitted by the light-emitting member 64 in response to the instruction by the control unit 68 while the liquid developer is filled in the inner peripheral side of the second tubular member 62 and that of the third tubular member 63. The light emitted by the light-emitting member 64 is received by the light-receiving member 65, and the light-receiving member 65 converts the received light into an electric signal (i.e., voltage). Next, the receiver 651 amplifies the electric signal to a level such that the control unit 68 recognizes the electric signal. Then, the electric signal is transmitted to the control unit 68, and is detected as the concentration of the liquid developer. For example, as shown in FIG. 7, when the output voltage is 2.0V, concentration of the liquid developer is 0.0005%. Also, when the output voltage is 1.3V, concentration is 0.001%. After measurements are performed, the pump 12 is operated by the control unit 68, and the liquid developer is discharged through the liquid developer outlet 63a. Then, the liquid developer is returned to the separation and extraction device 82. While the series of concentration detection operations for the liquid developer is performed, the pump P9 is kept deactivated. Accordingly, the liquid developer in the first recovery container 279 does not supply to the separation and extraction device 82. When concentration of the liquid developer is less than or equal to a predetermined concentration, in other words, when the toner concentration in the carrier liquid becomes lower than a specified value and thus it is possible to judge that the liquid developer is separated into the toner and the carrier liquid, the pump P10 is operated by the control unit 68 and accordingly the extracted carrier liquid in the separation and extraction device 82 is conveyed to the carrier tank TY. Thus, the carrier liquid is conveyed to the carrier tank TY. In addition, when the concentration of the liquid developer is greater than the predetermined concentration, the driving motor 681 and the voltage applying device 69 are operated, and the separation operation of the liquid developer is continued.

Here, with the second tubular member 62 having the predetermined length, it is possible to detect accurately the toner concentration in the low concentration liquid developer, that is, the toner concentration included in the carrier liquid extracted by the separation and extraction device 82.

In addition, as illustrated in FIG. 8, when the inner peripheral surface of the tubular member 600 is preferably made of resin, the inner peripheral surface of the tubular member 600 diffusely reflects light. Therefore, the amount of light reaching the light-receiving member 65 is reduced. However, according to the concentration detection device 60, the inner peripheral surfaces of the first tubular member 61, the second tubular member 62, and the third tubular member 63 are preferably made of metal. Therefore, even when carrier liquid without toner is used for measurement, reduction in light attenuation in accordance with an increase of distance is less than that in a case that the above members are preferably made of resin. Accordingly, it is possible to detect accurately the concentration of liquid developer.

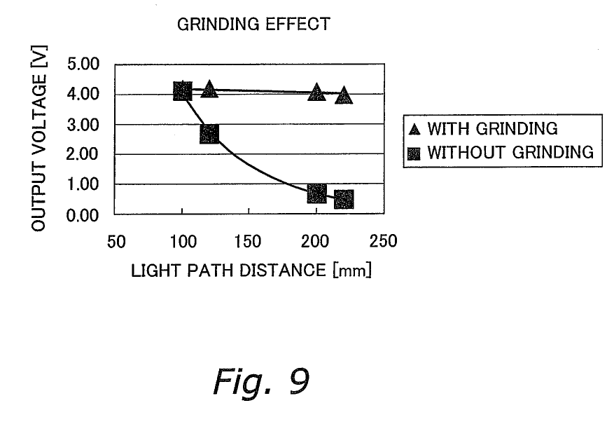

In addition, as illustrated in FIG. 9, when the inner peripheral surface of the tubular member 600 is not ground, the inner peripheral surface of the tubular member 600 diffusely reflects light. Therefore, the amount of light reaching the light-receiving member 65 is reduced. However, according to the concentration detection device 60, the inner peripheral surfaces of the first tubular member 61, the second tubular member 62, and the third tubular member 63 are ground. Therefore, even when carrier liquid without toner is used for measurement, reduction in light attenuation in accordance with an increase in distance is less than that in a case that the above members are not ground. Accordingly, it is possible to detect accurately concentration of the liquid developer.

### 3. Other Embodiments

(a) In the above embodiment, the light-emitting member 64 is disposed on the first tubular member 61 side, and the light-receiving member 65 is disposed on the third tubular member 63 side. However, the present invention is not limited to the configuration, and the light-emitting member 64 may be disposed on the third tubular member 63 side and the light-receiving member 65 may be disposed on the first tubular member 61 side.

(b) In the above embodiment, the liquid developer is exemplified, which includes toner functioning as dispersoid and carrier liquid functioning as dispersion medium. However, the present invention is applicable to the concentration measurement for a variety of liquid samples. For example, the present invention is applicable to the following measurements: measurement of the amount of contaminant in river water or sea water in which particulate contaminant (i.e., dispersoid) is dispersed in water (i.e., dispersion medium); measurement of the concentration of dye (i.e., dispersoid) dissolved in water (i.e., dispersion medium); measurement of the amount of color liquid (i.e., solute) dissolved in water (i.e., solvent); measurement of blood; and measurement of liquid sample after chemical reactions.

### General Interpretation

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applied to words having similar meanings such as the terms, “including,” “having,” and their derivatives. Also, the term “part,” “section,” “portion,” “member,” or “element” when used in the singular can have the dual meaning of a single part or a plurality of parts. Finally, terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A concentration detection device for measuring concentration of a solute or dispersoid included in a liquid sample, comprising:
a tubular member having
a liquid channel being formed in the interior thereof, liquid sample being configured to pass through the liquid channel,
an inlet inletting the liquid sample, and
an outlet discharging the liquid sample,
the liquid sample including are combination of solute and solvent or the combination of dispersoid and dispersion medium;
a light-emitting member being disposed on one end of the tubular member; and
a light-receiving member being disposed on the other end of the tubular member, the light receiving member receiving light emitted from the light-emitting member, and detecting a concentration of the liquid sample inlet into the interior of the tubular member.

2. The concentration detection device of claim 1, wherein the liquid sample is liquid developer including toner as the dispersoid and carrier liquid as the dispersion medium.

3. The concentration detection device of claim 1, wherein the inner peripheral surface of the tubular member is processed by a surface finish processing.

4. The concentration detection device of claim 1, wherein the inner peripheral surface of the tubular member has the ten-point average roughness Rz less than or equal to 1.0 micrometer (μm).

5. The concentration detection device of claim 1, wherein at least the inner peripheral surface of the tubular member is made of aluminum or silver.

6. The concentration detection device of claim 1, wherein the tubular member includes
a first tubular member having a first liquid channel through which liquid sample passes, the first liquid channel being formed in the interior thereof, the first tubular member including the inlet,
a second tubular member having a second liquid channel through which liquid sample passes, the second liquid channel being formed in the interior thereof, the second tubular member being disposed on one end of the first tubular member, and
a third tubular member having a third liquid channel through which liquid sample passes, the third liquid channel being formed in the interior thereof, the third tubular member including the outlet, the third tubular member being disposed on one end of the second tubular member on which the first tubular member is not disposed.

7. The concentration detection device of claim 6, wherein the first tubular member, the second tubular member, and the third tubular member are coaxially disposed.

8. An image forming device for forming an image with liquid developer including toner and carrier liquid, comprising:
an electrostatic latent image bearing member being configured to bear an electrostatic latent image on the surface thereof;
an electric charging device electrically charging the surface of the electrostatic latent image bearing member;
an exposing device forming the electrostatic latent image by exposing the surface of the electrostatic latent image bearing member based on image data;
a developing device forming a toner image by developing the electrostatic latent image with the toner by supplying the liquid developer to the electrostatic latent image bearing member;
a transfer device transferring the toner image to a transfer-target;
a cleaning device removing the liquid developer left on the electrostatic latent image bearing member after the toner image is transferred by the transfer device;
a separation and extraction device performing a separation and extraction processing with respect to the liquid developer removed from the electrostatic latent image bearing member by the cleaning device;
a concentration detection device detecting concentration of the liquid developer in the interior of the separation and extraction device; and
a control unit judging whether the separation and extraction processing is completed in the separation and extraction device based on a result of concentration detected by the concentration detection device.
